(19) United States
(12) Patent Application Publication
(10) Pub. No.: US 2010/0030948 A1
(43) Pub. Date: Feb. 4, 2010

(54) SOLID STATE STORAGE SYSTEM WITH DATA ATTRIBUTE WEAR LEVELING AND METHOD OF CONTROLLING THE SOLID STATE STORAGE SYSTEM

(76) Inventors: Yang Gi MOON, Gyeonggi-do (KR); Dae Hee YI, Seoul (KR)

Correspondence Address: LADAS & PARRY LLP, 224 SOUTH MICHIGAN AVENUE, SUITE 1600, CHICAGO, IL, 60604, US

(21) Appl. No.: 12/369,278

(22) Filed: Feb. 11, 2009

(30) Foreign Application Priority Data
Jul. 30, 2008 (KR) 10-2008-0074383

(51) Int. Cl. G06F 12/02; G06F 12/00

(52) U.S. Cl. 711/103; 711/E12.001; 711/E12.008; 711/E12.059

(57) ABSTRACT

A solid state storage system is disclosed capable of performing wear leveling utilizing attributes of different types of data. The solid state storage system performs a control operation such that logical addresses are configured to be mapped to physical addresses of pages in multiple planes of a memory area. In addition, the continuous logical addresses are mapped to the physical addresses of the pages of the different planes. The logical addresses are subsequently grouped so as to define multiple data areas for programming data having different attributes. Accordingly, the data is allocated so as to reduce a life time deviation between planes.

### CROSS-REFERENCES TO RELATED PATENT APPLICATION

The present application claims priority under 35 U.S.C 119(a) to Korean Patent Application No. 10-2008-0074383, filed on Jul. 30, 2008, in the Korean Intellectual Property Office, which is incorporated herein by reference in its entirety as set forth in full.

### BACKGROUND

The present invention relates generally to a solid state storage system and a method of controlling the solid state storage system, and more particularly, to a solid state storage system utilizing wear leveling and a method of controlling the solid state storage system.

Generally, non-volatile memories have been used as memories for portable information apparatuses because non-volatile memories retain the data stored therein when power supplied to the memory is interrupted. Lately, solid state drives (SSD) using NAND flash memories are used in personal computers (PC) instead of hard disk drives (HDD). As a result, SSDs are expected to make inroads into the market share of the HDD.

In a solid state storage system such as the SSD, data files are generally controlled by writing, erasing, and updating data in pages designated by logical addresses that identify the data files. Specifically, the logical addresses and physical addresses of a data storage area are mapped using a flash translation layer (FTL) conversion. Data can be written, erased, and read at locations that are designated by the physical addresses that are mapped to the logical addresses when a command from a host (not shown) refers to the logical addresses. As is well known, each physical address represents the position of a page or a sub-block of the memory area.

FIG. 1 is a block diagram showing a memory area of the related art for storing data. The memory area includes a plurality of planes that are included in banks (not shown) of a NAND flash memory area.

Referring to FIG. 1, the memory area includes first to fourth planes (plane #0 to plane #3).

Each of the planes (plane #0 to plane #3) includes a plurality of pages. A plurality of pages in the same plane has physical addresses that are numbered serially in a vertical fashion.

That is, the first plane (plane #0) includes pages that correspond to serial physical addresses 0 to 1023 (PA0 to PA1023). The second plane (plane #1) includes pages that correspond to serial physical addresses 1024 to 2047 (PA1024 to PA2047). The third plane (plane #2) includes pages that correspond to serial physical addresses 2048 to 3071 (PA2048 to PA3071). The fourth plane (plane #3) includes pages that correspond to serial physical addresses 3072 to 4095 (PA3072 to PA4095).

The planes (plane #0 to plane #3) are mapped to the physical addresses as described above. Areas of the planes (plane #0 to plane #3) are additionally mapped to logical addresses (not shown), respectively. Data is then substantially programmed or read in those areas corresponding to the logical addresses.

In a solid state storage system, data is repetitively programmed and erased in NAND flash memory cells.

Generally, to update data of the NAND flash memory cells, the existing data in the NAND flash memory cells needs to be erased and new the data needs to be programmed in the NAND flash memory cells. This process is due to the NAND flash memory being a non-volatile memory. However, data may not be uniformly allocated to all of the flash memory cells during data programming. Rather, data may be allocated such that the data is concentrated to a specific cell That is, the life span of the specific cell or cells is decreased and may become worn out due to frequent data programming and erasing processes of the specific cell or cells. As a result, even though cells exists that are in a fresh state, overall performance of the solid state storage system may be restricted due to the existence of the worn cells despite the fresh cells.

Before each memory cell is worn out, wear leveling is performed to change physical locations of each memory zone or a storage cell in a plane to control uniform utilization of the cells.

However, the overall performance of the system may still be restricted since the wear leveling is performed in the corresponding plane. That is, even if a use frequency between cells in the same plane is equalized, overall performance may suffer as long as there is a specific plane where data is frequently programmed.

For example, attributes of data in the solid state storage system can be classified according to a data programming frequency.

In general, an OS (operating system) file, a word file, or an application file for data management is a large unit of data that is continuously programmed. These files are not repetitively updated. After the files are installed and programmed to the memory cells, the files are rarely updated. Accordingly, the states of the cells corresponding to such data are relatively fresh.

Meanwhile, data such as a control code and a command is continuously updated or referred to repeatedly. This type of data is inconsecutive and has a small size. However, the aging of these cells related to the data is much faster since the data has a high update frequency.

During the processing of large unit data according to a command from the host, the large unit data can be preferentially concentrated on a specific plane if the data is programmed according to the logical addresses. Accordingly, the OS file, the word file, or the application file for data management can be stored in an arbitrary plane, e.g., the first plane (plane #0). Data that needs to be continuously updated and changed can be randomly stored in other planes such as the second to fourth planes (plane #1 to plane #3).

That is, the memory area can be divided into an area 10 that has a low program or erase frequency and an area 20 that has a high program or erase frequency according to attributes of the data stored therein. As such, the area 10 that has a low program frequency corresponds to one plane (plane #0) and the area 20 that has a high program frequency corresponds to the other planes (plane #1 to plane #3). If wear leveling is performed for each plane, it is difficult to equalize a use frequency between the planes.

FIG. 2 is a graph showing a life cycle of each of the planes (plane #0 to plane #3) shown in FIG. 1.

Referring to FIG. 2, it can be clearly seen that the life cycle of cells in the area 10, which have the low program frequency, does not reach the upper limit of its life cycle. However, the life cycle of the cells in the area 20, which have the high program frequency, reaches the upper limit of its life cycle.

As such, a wear leveling deviation between the planes may be large even though planes exist that are not worn out since wear leveling is performed for each plane individually. As a result, the restricted memory area cannot be used efficiently.

### SUMMARY

A solid state storage system that can perform wear leveling to decrease a life time deviation between planes or chips is disclosed herein.

A method of controlling a solid state storage system that can perform wear leveling to decrease a life time deviation between planes or chips is disclosed herein.

In one embodiment of the present invention, a solid state storage system performs such that logical addresses are configured to be mapped to physical addresses of pages in planes of a memory area, while the continuous logical addresses are mapped to the physical addresses of the pages of the different planes.

In another embodiment of the present invention, a solid state storage system includes a micro controller unit (MCU) configured to perform a control operation such that logical addresses are mapped to physical addresses of pages in planes of a memory area; and a memory area configured to be controlled such that data having a large size of a page unit or more is distributed to the pages in the different planes according to the mapping result.

In another embodiment of the present invention, a method of controlling a solid state storage system that includes a memory controller to control a memory area and a micro controller unit (MCU) to control the memory controller includes allowing the MCU to perform a control operation such that continuous logical addresses are mapped to physical addresses of pages of different planes; allowing the memory controller to program data in the memory area according to a mapping method of the logical addresses, in response to a command from an external host; and allowing the MCU to perform wear leveling for each plane, when the wear leveling is performed.

According to one embodiment of the present invention, it is possible to decrease a life time deviation between planes or chips in a memory area. That is, if logical addresses are distributed and mapped to the planes or chips at the time of mapping, the memory area can be controlled by the logical addresses during a data process, and distributed processing can be performed on all of the planes or chips. If wear leveling is performed using a simple mapping method, the life time of cells between the planes or chips can be equalized. Further, restricted resources can be efficiently used.

These and other features of the embodiments of the present invention are described below in the section “Detailed Description.”

### BRIEF DESCRIPTION OF THE DRAWINGS

Features and embodiments of the present invention are described in conjunction with the attached drawings, in which:

FIG. 1 is a block diagram showing a memory block according to the related art;

FIG. 2 is a graph illustrating a life cycle of a memory block shown in FIG. 1;

FIG. 3 is a block diagram showing a solid state storage system according to one embodiment of the present invention;

FIG. 4 is a map showing an address mapping relationship shown in FIG. 3;

FIG. 5 is a block diagram showing a memory area shown in FIG. 3; and

FIG. 6 is a flowchart illustrating a method of controlling a solid state storage system shown in FIG. 3.

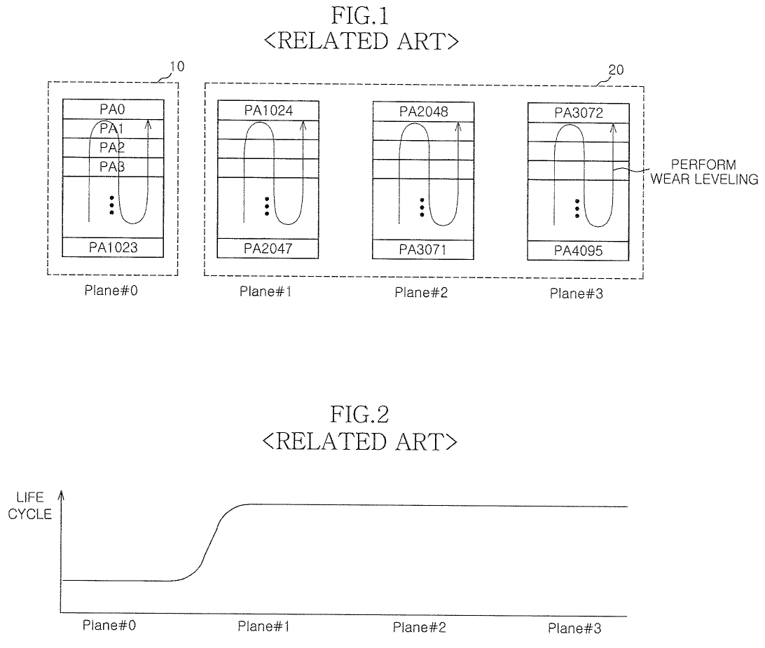

### DETAILED DESCRIPTION

Hereinafter, a solid state storage system according to one embodiment of the present invention will be described with reference to the accompanying drawings.

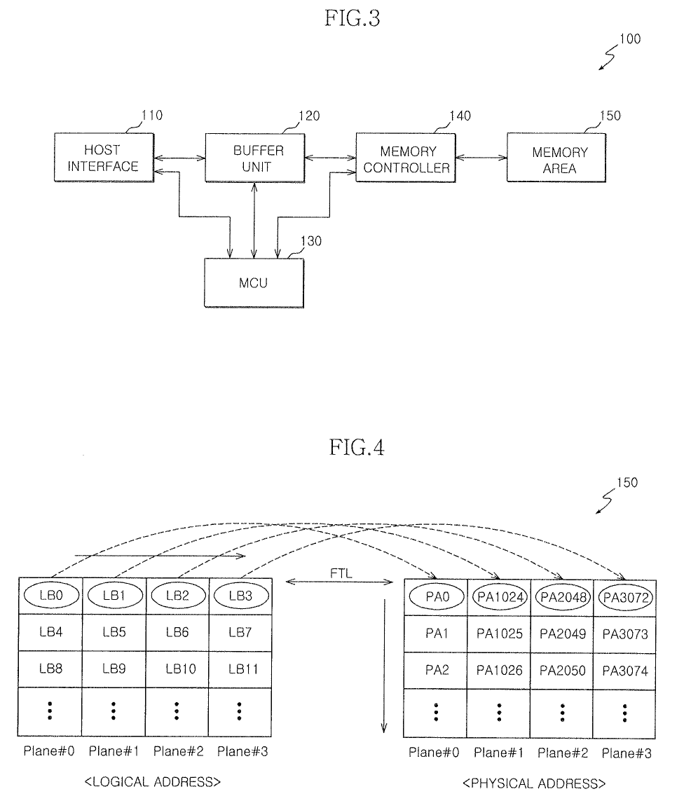

FIG. 3 is a block diagram showing a solid state storage system 100 according to one embodiment of the present invention.

Referring to FIG. 3, the solid state storage system 100 can be configured to include a host interface 110, a buffer unit 120, a micro controller unit (MCU) 130, a memory controller 140, and a memory area 150.

The host interface 110 can be connected to the buffer unit 120. The host interface 110 can transmit and receive control commands, address signals, and data signals between an external host (not shown) and the buffer unit 120. An interface method between the host interface 110 and the external host (not shown) can be any one of a serial advanced technology attachment (SATA) method, a parallel advanced technology attachment (PATA) method, a SCSI method, a method using an express card, and a PCI-Express method, all of which are exemplary.

The buffer unit 120 can buffer output signals from the host interface 110 or store mapping information between logical addresses and physical addresses and block allocation information of a memory area. The buffer unit 120 can be a buffer using a static random access memory (SRAM).

The MCU 130 can exchange control commands, address signals, and data signals with the host interface 110 or control the memory controller 140 using the above signals.

In particular, the MCU 130 according to one embodiment of the present invention can use an FTL conversion to distribute and map the logical addresses to planes of the entire memory area. In the related art, physical addresses increase sequentially for each page location in the same plane as a physical area where data is substantially stored. Further, the logical addresses are also sequentially mapped to increase in the same plane. Therefore, predetermined cells in the same plane are used repetitively according to logical addresses that are referred to repeatedly. As a result, planes having large program frequency differences corresponding to different data attributes are generated, as described above.

However, according to one embodiment of the present invention, physical addresses of a storage area where data is substantially programmed or read, sequentially increase for each page location in the same plane as in the related art. However, continuous logical addresses are allocated so as to designate pages of different planes. That is, the MCU 130 performs a control operation such that the logical addresses are sequentially mapped to the different planes using the FTL conversion.

In this case, distributed mapping is performed by the MCU 130. However, separate firmware or software, or a dedicated processor can be additionally provided to perform the distributed mapping.

The memory controller 140 can select a predetermined NAND flash memory element ND (not shown) from a plurality of NAND flash memory elements of the memory area 150, and provide a program command, an erase command or a read command to the selected NAND flash memory element. The memory controller 140 can be controlled according to the mapping method of the MCU 130, and large unit data that is received continuously can be distributed and processed in the memory area 150.

Specifically, continuous large unit (bulk unit) data can be distributed and stored with respect to all planes according to the logical addresses that are distributed and mapped to pages of different planes. As a result, the generation of a specific plane having a low program frequency and a concentration of large unit data can be prevented Therefore, a life time deviation between the planes can be reduced even though wear leveling is performed individually for each plane. In this case, the large unit data is data exceeding a single page unit and the bulk unit data is data having a size of 2 Mbytes or more.

The memory area 150 can be controlled by the memory controller 140 and data program, erase, and read operations can be performed in the memory area 150. In particular, the memory area 150 can be controlled according to the logical block addresses that are distributed and mapped by the MCU 130. As a result, data can be uniformly distributed and stored in all of the planes. Here, the memory area 150 can include a NAND flash memory. For convenience of explanation, the memory area 150 is exemplified to include one NAND flash memory, but can include a plurality of NAND flash memories.

The above structure will be described in detail with reference to the following drawing.

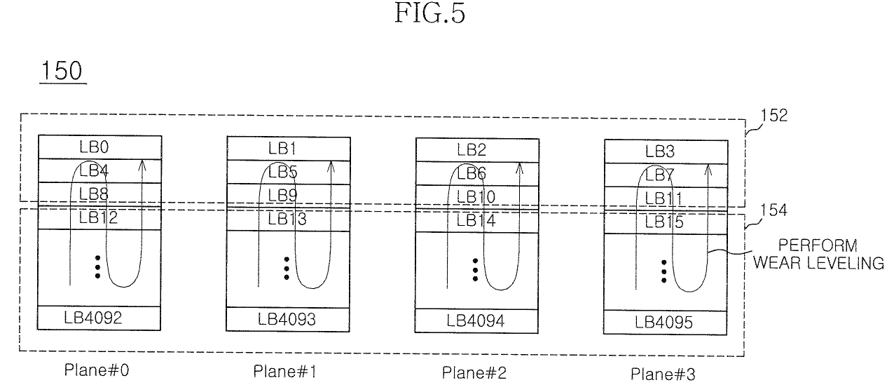

FIG. 4 is a block diagram showing a mapping relationship between logical addresses LB and physical addresses PA. In this case, the memory area (refer to reference numeral 150 of FIG. 3) includes four planes, which is only exemplary.

Referring to FIG. 4, the logical addresses LB are distributed and mapped to the physical addresses PA of all planes of the memory area (refer to reference numeral 150 of FIG. 3).

That is, a mapping direction of the logical addresses LB is orthogonal to a numbering direction of the physical addresses PA as shown in FIG. 4. For example, the physical addresses PA are sequentially increased and numbered in a vertical direction for each page location in the same plane. However, according to one embodiment of the present invention, the logical addresses LB are sequentially mapped in a horizontal direction to designate pages in different planes.

That is for example, the logical address 0 (LB0) is mapped to the physical address 0 (PA0), the logical address 1 (LB1) is mapped to the physical address 1024 (PA1024), the logical address 2 (LB2) is mapped to the physical address 2048 (PA2048), and the logical address 3 (LB3) is mapped to the physical address 3072 (PA3072).

Accordingly, from the mapping result of the logical addresses LB for each plane, it's clearly shown that the mapping addresses of the logical addresses LB within the same plane increase by the number of planes in the memory area (refer to reference numeral 150 of FIG. 3). That is, as shown in FIG. 4, the logical addresses in plane 1 (Plane #0) increase by a factor of 4. For example, the logical addresses are mapped as LB0, LB4, LB8, etc.

FIG. 5 is a block diagram showing a memory area 150 that is grouped according to data attributes shown in FIG. 4.

Referring to FIG. 5, as described above, mapping addresses of the logical addresses LB in the same plane of the memory area 150 increase by the total number of planes in the memory area (refer to reference numeral 150 of FIG. 3).

The memory area 150 can be configured to include a first data area 152 and a second data area 154.

The first data area 152 includes a first logical address group grouping logical addresses LB0 to LB11. The second data area 154 includes a second logical address group grouping logical addresses LB12 to LB4095. The first data area 152 can store data that is referenced according to the first logical address group (LB0 to LB11) and the second data area 154 can store data that is referenced according to the second logical address group (LB12 to LB4095).

According to one embodiment of the present invention, the first data area 152 can store data that has a low program frequency attribute and the second data area 154 can store data that has a high program frequency attribute.

As described above, according to the attributes of OS and application program data, large unit (bulk unit) data is continuously programmed. These data files have attributes where an update frequency is low. Accordingly, the data files have a very low program or erase frequency, e.g., only one time or several times The data can be preferentially programmed in the first data area 152 according to the continuous logical addresses. As shown in FIG. 5, the large unit OS and application program data can be distributed and programmed to pages of different planes in the first data area 152 according to the continuous logical addresses LB since the logical addresses LB are continuously mapped between the planes.

Meanwhile, the second data area 154 can store data that is corresponds to a control code and a command that requires frequent updating according to user action and command. Thus, data having a high use frequency can be uniformly distributed to planes in the second data area 154 according to the continuous logical addresses LB.

According to one embodiment of the present invention, a data group having a high use frequency and a data group having a low use frequency coexist for each of the planes (a plane #0 to a plane #3). Accordingly, when wear leveling is performed, the wear leveling is performed for each of the planes individually (a plane #0 to a plane #3) according to an erase limitative value or an erase cycle. For example, in the case of a single level cell (SLC), the erase cycle may be 100,000 cycles, and in the case of a multi level cell (MLC), the erase cycle may be 5,000 cycles. Therefore, an erase reference value for the wear leveling can be set according to a cell level.

As a result, the life time deviation between the planes can be substantially reduced since a data group having a high data use frequency and a data group having a low data use frequency coexist for each of the planes.

The plane described herein is exemplary and for convenience of explanation, but a description can be made on the basis of a single chip. According to one embodiment of the present invention, the life time deviation between the chips can be reduced in the memory area including a plurality of chips (not shown).

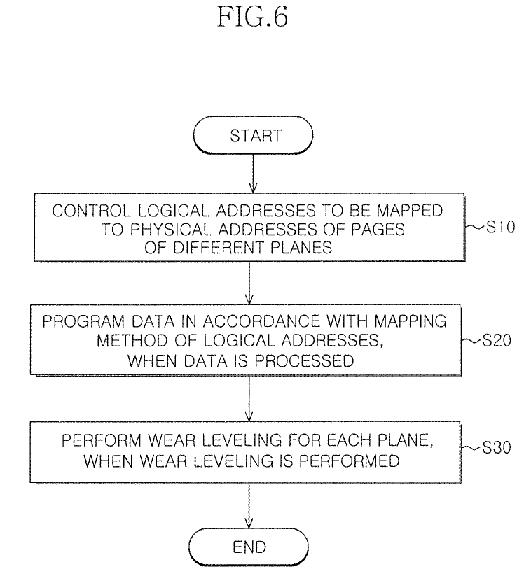

FIG. 6 is a flowchart illustrating a method of controlling a solid state storage system 100 shown in FIG. 3.

Referring to FIGS. 3 to 6, a method of controlling the solid state storage system 100 according to one embodiment of the present invention will be described.

First, the MCU 130 according to one embodiment of the present invention, performs a control operation such that continuous logical addresses are mapped to physical addresses of blocks in different planes (S10).

When the logical addresses and the physical addresses are mapped, the logical addresses and the physical addresses are uniformly distributed and mapped with respect to all of the planes such that data can be distributed and arranged according to the logical addresses.

The MCU 130 can then group the logical addresses such that the memory area can be divided into predetermined data areas

Specifically, in order to divide a storage area according to data attributes, the size of the storage area in the memory area, that is, the number of allocated pages, can be set in consideration of the size of data and a program frequency. That is, the predetermined storage area size can be set in advance according to a type of data having a large size and a low program frequency. Accordingly, a predetermined range of the logical addresses is set as a first data area. At the same time, data having a small size and needing frequent updating is set as a second data area by grouping the predetermined range of the logical addresses in consideration of a data operation. This process is only performed to facilitate address and data control, and is not essential.

The memory controller 140 programs data to the memory area according to the logical address mapping method in response to a command from the external host (S20).

As described above, data having a low update frequency after being programmed is preferentially programmed in the first data area according to the first logical address group. Data that is frequently updated is distributed and arranged for each page in different planes according to the second logical address group.

At a predetermined point in time, the MCU 130 performs wear leveling for each plane individually (S30).

When wear leveling is performed, the wear leveling is performed for each plane. That is, the wear leveling is for each of the planes according to the predetermined erase cycle or the erase limitative value. If the wear leveling is performed for each of the planes, physical locations of data can be changed in the same plane according to a program frequency. Even though the wear leveling is performed for each of the planes individually, data having a high program frequency and data having a low program frequency coexist for each plane. Therefore, the life time deviation between the planes or the chips can be reduced.

As such, according to the embodiments of the present invention, the life time deviation between the planes or the chips where data is physically stored can be reduced by distributing and mapping the physical locations where the data is stored.

While certain embodiments have been described above, it will be understood that the embodiments described are by way of example only. Accordingly, the device and method described herein should not be limited based on the described embodiments. Rather, the devices and methods described herein should only be limited in light of the claims that follow when taken in conjunction with the above description and accompanying drawings.

What is claimed is:

1. A solid state storage system comprising,
a memory area having a plurality of planes having a plurality of pages defined within each plane,
wherein a control operation is performed such that continuous logical addresses are mapped to physical addresses of the pages in the planes of the memory area, and
wherein the continuous logical addresses are mapped to the physical addresses of the pages of different planes.

2. The solid state storage system of claim 1 further comprising,
a controller configured to map the continuous logical addresses, and
wherein the controller is configured to perform a flash translation layer (FTL) conversion on the continuous logical addresses and the physical addresses.

3. The solid state storage system of claim 2,
wherein the physical addresses are configured to sequentially increase for each location of the pages in the planes.

4. The solid state storage system of claim 1,
wherein the logical addresses in a same plane are configured to increase according to the total number of planes.

5. A solid state storage system, comprising:
a controller configured to perform a control operation such that continuous logical addresses are mapped to physical addresses of pages in planes of a memory area; and
the memory area configured to be controlled such that data requiring at least two pages is distributed to pages of different planes according to the mapping of the controller.

6. The solid state storage system of claim 5,
wherein the controller is configured to perform the control operation such that the continuous logical addresses are mapped to the physical addresses of the pages of the different planes.

7. The solid state storage system of claim 5,
wherein the controller is configured to perform a flash translation layer (FTL) conversion on the continuous logical addresses and the physical addresses.

8. The solid state storage system of claim 5,
wherein the physical addresses are configured to sequentially increase for each location of the pages in the planes.

9. The solid state storage system of claim 5,
wherein the logical addresses in a same plane are configured to increase according to the total number of planes.

10. A method of controlling a solid state storage system having a controller controlling a memory area having a plurality of planes, each plane having a plurality of pages, comprising:
performing a control operation such that continuous logical addresses are mapped to physical addresses of pages of different planes;
programming data in the memory area according to a mapping process for the logical addresses according to a command from an external host; and
performing wear-leveling for each plane.

11. The method of claim 10 further comprising,
performing a flash translation layer (FTL) conversion on the logical addresses and the physical addresses.

12. The method of claim 10,
wherein the control operation is performed such that the physical addresses sequentially increase for each location of the pages in the planes when the mapping is performed.

13. The method of claim 10,
wherein the control operation is performed such that data having a size of a page or more is distributed and programmed to pages of different planes according to the mapping.

14. The method of claim 10,
wherein a point of time for wear leveling is detected using a predetermined erase cycle or an erase limitative value.

15. A solid state storage system, comprising:
a first plane configured to include a plurality of pages; and
a second plane configured to include a plurality of pages,
wherein a control operation is performed such that the pages in the first plane and the pages in the second plane are mapped according to continuous logical addresses.

16. The solid state storage system of claim 15, further comprising:
a controller configured to map the continuous logical addresses,
wherein the controller is configured to perform a flash translation layer (FTL) conversion on the continuous logical addresses and physical addresses of individual pages.

17. The solid state storage system of claim 16,
wherein the physical addresses sequentially increase for each location of the pages in the planes.
